(19) United States
(12) Patent Application Publication
(10) Pub. No.: US 2025/0087727 A1
(43) Pub. Date: Mar. 13, 2025

(54) DEVICE FOR ANODE GAS RECIRCULATION IN A FUEL CELL SYSTEM

(71) Applicant: PIERBURG GMBH, NEUSS (DE)

(72) Inventors: STEFAN ROTHGANG, RHEINBERG (DE); MICHAEL-THOMAS BENRA, NEUSS (DE); ANDREAS BURGER, NEUSS (DE)

(73) Assignee: PIERBURG GMBH, NEUSS (DE)

(21) Appl. No.: 18/726,822

(22) PCT Filed: Jan. 7, 2022
(86) PCT No.: PCT/EP2022/050257

§ 371 Date: Jul. 5, 2024

(51) Int. Cl. H01M 8/04119; F04D 23/00; F04D 29/18; F04D 29/40; F04D 29/58

(52) U.S. Cl. CPC H01M 8/04164; F04D 23/008; F04D 29/188; F04D 29/403; F04D 29/584

(57) ABSTRACT

A device for an anode gas recirculation in a fuel cell system includes a blower, an outer housing defining the blower, a condensate drain channel, a receiving element arranged at the outer housing, and a drain valve arranged in the receiving element. The blower incudes a rotor wheel, a delivery channel, an electric motor having a drive shaft to which the rotor wheel is attached, and a cooling channel through which an anode gas flows. The delivery channel extends from a delivery channel inlet to a delivery channel outlet. The cooling channel at least partially surrounds the electric motor of the blower. The condensate drain channel extends below the cooling channel in the outer housing. The cooling channel is fluidically connected to the condensate drain channel. The condensate drain channel is opened and closed by the drain valve so that a liquid can be drained from the condensate drain channel.

### CROSS REFERENCE TO PRIOR APPLICATIONS

This application is a U.S. National Phase application under 35 U.S.C. § 371 of International Application No. PCT/EP2022/050257, filed on Jan. 7, 2022. The International Application was published in German on Jul. 13, 2023 as WO 2023/131412 A1 under PCT Article 21 (2).

### FIELD

The present invention is directed to a device for anode gas recirculation in a fuel cell system, the device comprising a blower with a rotor wheel and a delivery channel extending from a delivery channel inlet to a delivery channel outlet, and an electric motor with a drive shaft to which the rotor wheel is attached.

### BACKGROUND

Fuel cell systems are used to convert the chemical reaction energy of a continuously supplied fuel, in particular hydrogen, and an oxidizing agent, usually oxygen, into electrical energy that can be used, for example, as drive energy for vehicles. The hydrogen path of a low-temperature fuel cell of the type commonly used in vehicles essentially consists of the supply line for the pure hydrogen via a pressure-reducing and metering valve, the actual fuel cell unit, and a recirculation path that connects the outlet of the fuel cell unit with its inlet, i.e., the hydrogen supply line, in a gas-tight manner. The resulting circuit is known as the anode gas recirculation circuit. This anode gas recirculation circuit is necessary to prevent hydrogen from being emitted unused into the atmosphere, which is caused by the fact that the fuel cell unit is supplied with fresh hydrogen in excess of the stoichiometric ratio. The anode gas circuit is therefore configured as a closed circuit, and the unused hydrogen is returned to the supply line behind the hydrogen dosing unit via a recirculation blower. Blowers of this kind are, for example, configured as side channel blowers. These blowers are usually driven by electric motors which are supplied with power from the vehicle battery when the vehicle is in operation. The problem with these drive systems is the high heat generation of the electronic components and the stator windings.

In addition to the unused hydrogen, the recycled anode gas consists of nitrogen, which comes from the fresh air of the fuel cell unit, and water vapor. Liquid product water is also present at the outlet of the fuel cell unit, which is also conveyed via the recirculation blower.

In order to remove the water from the gas mixture, it is necessary to separate the product water from the gas flow. Condensers are used therefor. The water must furthermore be drained from the space in which it is collected, for which purpose switching valves are used that can be opened when the fuel cell is in operation, whereby the water is returned to the cathode of the fuel cell or is separated.

A unit of this kind is described, for example, in DE 10 2007 033 203 A1. DE 10 2007 033 203 A1 describes an anode gas recirculation blower where a side channel of the compressor is configured on the housing cover. A channel that acts as a separator extends in a radial direction from an interception area of the side channel and is inclined downwards. This channel leads into a further outlet channel in which a drain valve is located. The degree of separation of this arrangement is not, however, sufficient, so that an additional separator is required.

DE 10 2017 221 309 A1 describes an anode gas recirculation blower, in the housing of which a gas liquid separator is integrated which comprises a collecting tank arranged below the blower from which a channel protrudes in which a drain valve is arranged. An additional large packaging space is required despite the integration of the separator into the housing of the blower.

### SUMMARY

An aspect of the present invention is to provide a device for anode gas recirculation in a fuel cell system which provides an adequate separation and removal of water from the anode gas circuit and which reliably prevents an overheating of the electric motor. The packaging space required for these functions should furthermore be as minimal as possible.

In an embodiment, the present invention provides a device for an anode gas recirculation in a fuel cell system which includes a blower, an outer housing which defines the blower, a condensate drain channel, a receiving element arranged at the outer housing, and a drain valve arranged in the receiving element. The blower comprises a rotor wheel, a delivery channel, an electric motor comprising a drive shaft to which the rotor wheel is attached, and a cooling channel through which an anode gas flows. The delivery channel extends from a delivery channel inlet to a delivery channel outlet. The cooling channel is arranged to at least partially surround the electric motor of the blower. The condensate drain channel extends below the cooling channel in the outer housing. The cooling channel is fluidically connected to the condensate drain channel. The condensate drain channel is configured to be opened and closed by the drain valve so that a liquid can be drained from the condensate drain channel.

### BRIEF DESCRIPTION OF THE DRAWINGS

The present invention is described in greater detail below on the basis of embodiments and of the drawings in which:

FIG. 1 shows a perspective view of a device for anode gas recirculation in a fuel cell system according to the present invention;

FIG. 2 shows a perspective view of the device from FIG. 1 with the outer housing part cut away;

FIG. 3 shows a cross-section of the device from FIG. 1 viewed from above; and

FIG. 4 shows a cross-section through the outer housing of the device from FIG. 1 in the area of the condensate drain channel.

### DETAILED DESCRIPTION

The device for anode gas recirculation in a fuel cell system according to the present invention comprises a blower, the rotor wheel of which is rotatably arranged in a delivery channel so that the anode gas is conveyed by the rotor wheel from a delivery channel inlet to a delivery channel outlet. The rotor wheel is driven by an electric motor which drives a drive shaft on which the rotor wheel is attached. According to the present invention, the blower comprises a cooling channel through which the anode gas flows and which at least partially surrounds the electric motor of the blower. This cooling channel is fluidically connected to a condensate drain channel which extends below the cooling channel in an outer housing which axially and radially bounds the blower. This condensate drain channel can be opened or closed by a drain valve, which is usually performed depending on the level of the condensate in the drain channel. According to the present invention, the drain valve is at least partially, i.e., at least with its closing member, received in a receiving element at the outer housing. The separated liquid can thus be drained from the condensate drain channel via the drain valve. The outer housing may comprise several housing parts, one of which has the receiving element. This housing part may limit the blower both radially and axially. The cooling channel is usually arranged upstream of the delivery channel and also serves as a separator so that the separated water no longer enters the delivery channel, which also improves the efficiency and function of the blower. This allows the heat generated by the electric motor to be reliably dissipated and the electric motor to be protected against overheating. The arrangement of the drain valve directly in the outer housing eliminates the requirement of additional interfaces. This simplifies sealing and reduces the packaging space required.

It should be noted for the entire disclosure hereof, that the terms above, below, under, over, down or up respectively refer to an installation direction in which the blower is, for example, installed in a vehicle. It is always assumed that the center of gravity of the earth serves as a reference point for the blower. The terms always refer to the direction of the acting gravitational force, wherein it is assumed that, for example, the vehicle is standing on a flat surface that is perpendicular to the direction of gravity. If a first element is arranged above a second element, this means that this first element is further away from the center of gravity than the second element and a fluid would be forced towards the second element due to the force of gravity. The closing element of the drain valve and the condensate drain channel are arranged so that the water always flows out of the cooling channel towards the closing element through the condensate drain channel due to the force of gravity. When the closing element opens, the water is conveyed to the cathode by the existing force of the pressure gradient.

In an embodiment of the present invention, the receiving element is configured at a head housing part of the outer housing that axially defines the blower at the bottom. The separated water accordingly flows down to the drain valve and defines a barrier in front of the valve that prevents air from being sucked in when the valve is open. The condensate is thus discharged at the lowest point of the blower.

In an alternative or supplementary configuration, the receiving element is configured at a radially outer motor housing part that radially surrounds the electric motor of the blower. This means that additional holes or channels in the other housing parts are not required, thereby simplifying assembly and production. A first condensate flow can also be discharged from the cooling channel via the motor housing part, and a second condensate flow from the delivery channel of the blower, wherein a separate drain valve can respectively be used.

The cooling channel can, for example, be configured as a droplet separator, wherein the droplets can be drained off via the condensate drain channel, which can be opened and closed via the drain valve. The cooling channel can be configured as a droplet separator in different ways. Components or precautions must in any case be taken to at least partially separate the water from the anode gas. This can be achieved, for example, via centrifugal separation or by components that force the gas flow to change direction. The fact that the temperature of the anode gas flow is usually below 100° C. is also beneficial, as it is suitable for cooling the electronics and the stator of the electric motor. The cooling channel can at the same time be used, however, as a condenser by providing appropriate components or by guiding the anode gas around the electric motor at a sufficient speed in a spiral. Both of these result in the water being deposited on the components or on the outer wall due to its higher inertia compared to the gas, thereby allowing the water to be drained off via a condensate drain. This means that the functions of cooling and condensation are realized in the cooling channel in a very small packaging space and in a single process step. The use of a separate coolant can be completely avoided. The drain valve controls the condensate drain channel so that it can be emptied when the fuel cell is operating, and the water can be fed back to the cathode or drained from the system.

In a further embodiment of the present invention, the cooling channel can, for example, comprise an opening that defines an inlet of the condensate drain channel and an anode gas outlet that leads to the delivery channel inlet. The moist anode gas stream is accordingly divided into the condensate stream and a dehumidified anode gas stream in the downstream section of the cooling channel by the arrangement of the opening for the condensate and the anode gas outlet. Additional connecting lines or separators can be avoided so that production and assembly can be carried out cost-effectively.

The actuator of the drain valve can, for example, be an electromagnetic actuator. Such an electromagnet can be configured to be small and switch very quickly. This means that energy consumption and space requirements are very low. The drain valve can furthermore be configured as a proportional valve which can also be used to blow off nitrogen.

In a further embodiment of the present invention, the drain valve can, for example, be switched depending on the level of liquid in the condensate drain channel. The drain channel must not be completely filled so that condensation water can get back into the cooling channel; the drain channel should only be emptied so that no air is sucked in from the outside. Accordingly, either a liquid level should always remain upstream of the valve or the emptying should take place under the condition of a secured, driving flushing gradient between cathode and anode, as is the case during active operation of the fuel cell.

In an embodiment of the present invention, the condensate drain channel has an extension geodetically above a closing element of the drain valve which serves as a reservoir in which condensate can be stored. This means that the emptying intervals can be chosen to be longer.

The drain valve is advantageously connected electrically to a control unit of the blower. The drain valve can accordingly either be controlled completely via the control unit, so that a separate control unit is not required, or at least data that can cause the drain valve to be triggered can be transmitted to the drain valve. This reduces the costs for the electronics of the drain valve.

In order to make this electrical connection as fail-safe as possible, electrical contact lines via which the control unit of the blower is connected to the actuator of the drain valve are arranged in the outer housing. Additional external lines that are exposed to the environment can thereby be avoided.

It is furthermore advantageous if the electric contact lines project from the outer housing as contact lugs in the area of the receiving element of the drain valve, wherein corresponding contact elements, which are connected to the coil and/or a control unit of the actuator, are arranged at the actuator, so that by inserting the drain valve, an electric contact to the coil and/or to the control unit of the actuator is established. No additional electric connection accordingly needs to be made when the drain valve is installed, but the electric connection is actually made as a result of the mechanical arrangement of the drain valve in the receiving element.

The drain valve can, for example, be configured as a plug valve, wherein the closing member projects into the receiving element and the actuator projects at least partially out of the outer housing, wherein an actuator housing is attached to the outer housing. The actuator thereby remains easily accessible and the attachment is simplified. The space requirement is nevertheless very small due to the integration.

A valve seat of the drain valve can in particular be configured at the outer housing. A separate production of a separate, inner flow housing of the valve can in this case be avoided so that the number of components is reduced.

It is furthermore advantageous if a wall that defines the lower boundary of the cooling channel is configured so that it slopes towards an opening that defines the inlet of the condensate drain channel. The entire water that drips down the walls is thereby reliably guided into the opening and thus to the condensate drain by the force of gravity.

In a further embodiment of the present invention, the inlet of the condensate drain channel can, for example, be arranged at the inner wall of the outer housing, adjacent to the lowest area of the downwardly limiting wall, since the main part of the water settles on this outer wall and there runs down. This is due to the fact that the outer wall is usually colder than the inner wall, against which the stator is placed, and due to the flow of the anode gas which usually circulates around the electric motor, at least in sections, causing the heavier water droplets to be forced outwards against the radially limiting wall. This provides that the separated water is removed from the cooling channel as quickly and completely as possible. The lowest area of the inner wall is understood to be the area near the downward-facing sloping wall where the water flows due to gravity.

Both the condensate drain channel and the receiving element for the drain valve can, for example, be configured in a radial extension of the outer housing. The drain valve thereby remains easily accessible and the connection for draining the water also remains accessible.

It is also advantageous if the anode gas outlet of the cooling channel is axially offset from the inlet of the condensate drain channel and is located above the inlet of the condensate drain channel. With such an arrangement, the condensate usually accumulates below the anode gas outlet of the cooling channel in order to reach the condensate drain channel and thus usually does not flow against the force of gravity into the delivery channel. This means that the anode gas flow is effectively separated from the condensate flow.

In a further embodiment of the present invention, the anode gas outlet of the cooling channel can, for example, be arranged above the delivery channel and radially offset inwards towards the inner wall of the outer housing, and has a radial distance to the inner wall. The condensate, which runs along the inner wall, does not thereby reach the anode gas outlet of the cooling channel since the wall does not lead directly into the anode gas outlet due to the radial distance. The condensate accordingly flows almost completely through the condensate outlet.

In an embodiment of the present invention, the cooling channel can, for example, surround the electric motor in a helical shape. Separation accordingly takes place in the form of a centrifugal separator. To achieve this, the cooling channel must not be configured with a cross-section that is too large, but rather a sufficient flow velocity must be provided in the cooling channel. If this is the case, the heavier water droplets are accelerated against the outer wall and flow down the wall to the condensate drain channel.

This provides a device for anode gas recirculation in a fuel cell system that requires little packaging space and at the same time provides cooling for the drive motor and water separation from the anode gas stream. It furthermore provides a controlled discharge of the separated condensate. The functions of the drive and the delivery, the cooling of the drive, the condensate separation, and the control of the discharge of the condensate are thus combined in a single component.

An embodiment according to the present invention is shown in the figures and is described below.

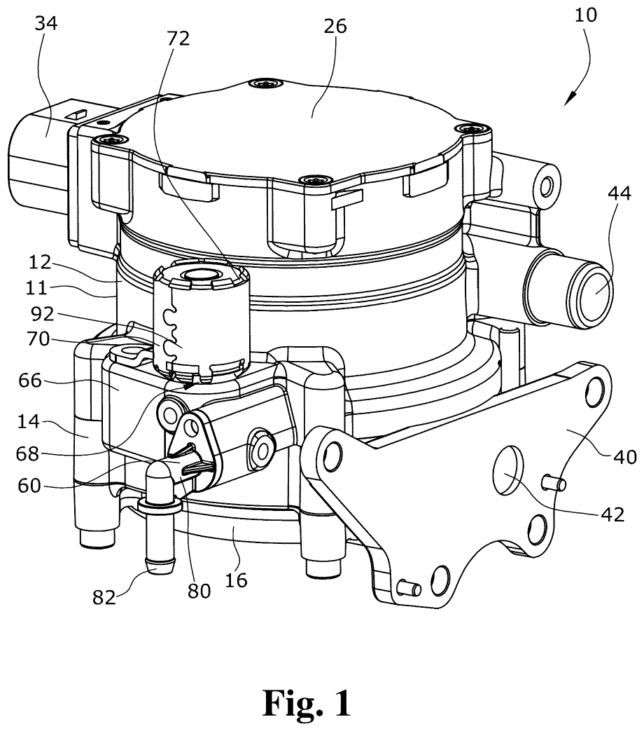

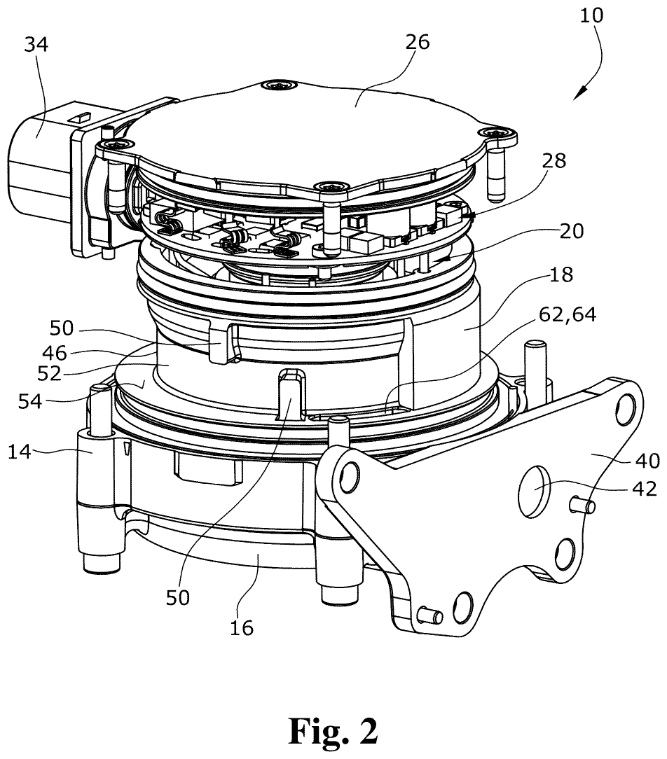

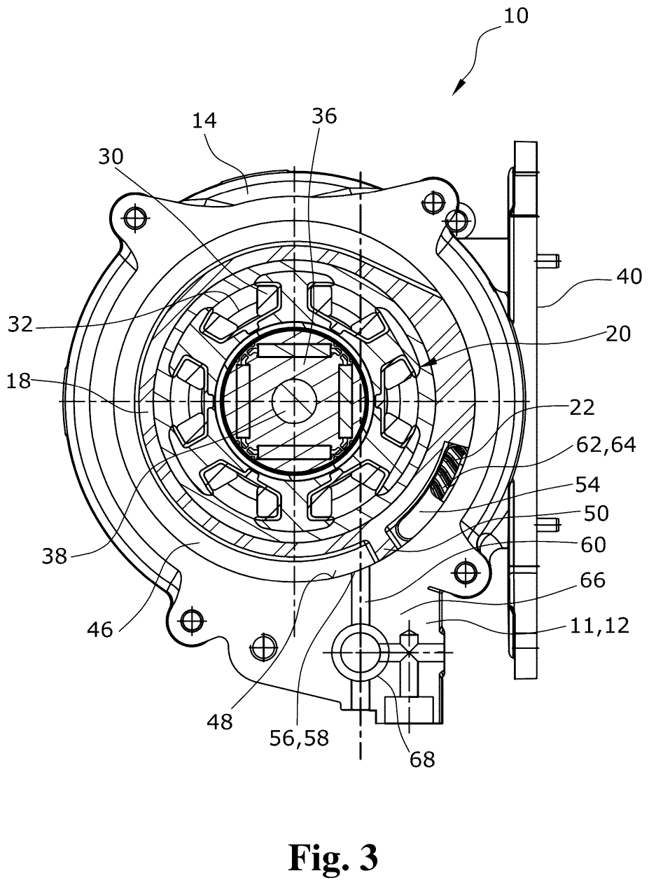

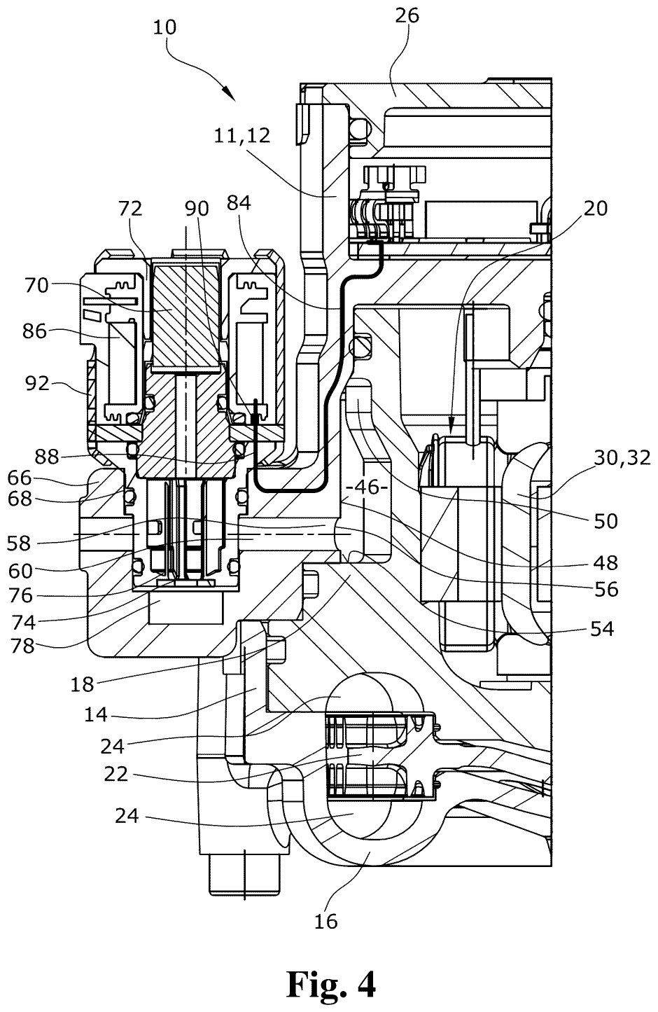

The anode gas recirculation device shown in FIGS. 1 to 4 consists of a blower 10, which has an outer housing 11 that is formed by a radially outer motor housing part 12 and a blower housing 14, which may have a blower head cover 16 or be manufactured in one piece therewith, as is shown in FIG. 4. The outer motor housing part 12 radially surrounds an inner motor housing part 18 in which an electric motor 20 is arranged. The electric motor 20 drives a rotor wheel 22 which rotates in the blower housing 14, via which an anode gas is delivered via a delivery channel 24, which is at least partially provided in the blower housing 14, in the blower head cover 16, which axially downwardly delimits the delivery channel 24, and in the inner motor housing part 18. The outer motor housing part 12 is attached to the blower housing 14 and is closed on the axial side opposite the blower head cover 16 by a cover 26, under which a control unit 28 of the electric motor 20 is arranged, which, like the windings 30 of a stator 32 of the electric motor 20, is connected to a voltage source via a plug 34. The stator 32 corresponds in a known manner with a permanent magnetic rotor 36 which is firmly attached to a drive shaft 38 on which the rotor wheel 22 is attached.

In the present embodiment, a flange 40 is configured at the blower housing 14, at which a delivery channel outlet 42 is configured, which is fluidically connected to the delivery channel 24. A cooling channel inlet 44 is furthermore configured at the outer motor housing part 12, which leads into a cooling channel 46 configured between the inner motor housing part 18 and the outer motor housing part 12, and at least partially surrounds the electric motor 20, and into which anode gas containing water flows. The cooling channel 46 serves to dissipate heat from the electric motor 20 and is radially outwardly defined by an inner wall 48 of the outer motor housing part 12.

The cooling channel 46 is configured with baffle plates 50 that extend axially into the cooling channel 46 from above and below so that a constant flow reversal is forced in the cooling channel 46. The baffle plates 50 serve as components of a droplet separator 52 since the water in the form of droplets or water vapor in the anode gas stream, due to the higher inertia of the water compared to the nitrogen and hydrogen present in the anode gas stream, bounce against the baffle plates 50, accumulate, and slide downwards due to the force of gravity, in particular at the inner wall 48, which is colder and in whose direction the droplets are moved by centrifugal force. A wall 54 that forms the lower axial wall of the cooling channel 46 is configured at an angle to an opening 56 at the inner wall 48 of the outer motor housing part 12 so that the drops collecting on the wall 54 slide towards this opening 56, which serves as the inlet 58 of a condensate drain channel 60. This is thus located in the immediate vicinity of this lowest point of the wall 54 at the inner wall 48. The condensate drain channel 60 extends through the outer motor housing part 12.

An anode gas outlet 62, through which the anode gas, now reduced by the water that has been removed, flows out of the cooling channel 46, can be arranged slightly higher than the inlet 58 of the condensate drain channel 60 in order to prevent water from flowing to the anode gas outlet 62. The anode gas outlet 62 is additionally located directly in the flow shadow of a final baffle plate 50, which removes water again immediately before the anode gas outlet 62. The anode gas outlet 62 is furthermore located in a radially inner area of the cooling channel 46, i.e., it has a radial distance to the inner wall 48, so that the slower water would also have to be transported inwardly and thus against the centrifugal force and the acceleration exerted by the baffle plate 50, in order to reach the anode gas outlet 62 of the cooling channel 46.

The anode gas outlet 62 leads directly into, or rather defines, a delivery channel inlet 64, through which the at least partially dehumidified anode gas flows into the delivery channel 24, where it is compressed and flows to the delivery channel outlet 42, which is fluidically connected to a fuel cell stack, while the condensate obtained flows into the condensate drain channel 60. This provides that the electric motor 20 is cooled and the process water is at the same time separated from the anode gas flow.

The condensate drain channel 60 extends into a radial extension 66 of the outer motor housing part 12, which is configured approximately opposite the inlet 58 of the condensate drain channel 60. A receiving element 68 for a drain valve 70 with an electromagnetic actuator 72 is configured in the radial extension 66, which is arranged below the inlet 58. The electromagnetic actuator 72 is connected to a closing member 74 which, for the purpose of closing and opening the condensate drain channel 60, can be placed on or lifted off a valve seat 76 which is configured in the area of the receiving element 68. An extension 78 of the condensate drain channel 60 is provided below the closing member 74 in the outer motor housing part 12, which serves as a reservoir so that a larger amount of condensate can be stored before the drain valve 70 must be opened for emptying. The condensate drain channel 60 is drained in accordance with the water level at the drain valve 70, wherein a water column should always remain in the area of the valve seat 76 during operation to prevent the undesired suction of gas from the outside. Downstream of the drain valve 70, the condensate drain channel 60 leads to a nozzle 80 inserted into the outer motor housing part 12, which defines a condensate outlet 82 of the condensate drain channel 60.

To simplify the assembly and the production of the device for anode gas recirculation, electrical contact lines 84 are configured in the outer motor housing part 12, via which the control unit 28 of the blower 10 is electrically connected to the electromagnetic actuator 72, in particular a coil 86 of the electromagnet, via contact lugs 88 which project from the outer motor housing part 12 in the region of the receiving element 68 and which are connected to contact elements 90 when the drain valve 70 is attached, which contact elements are configured at an actuator housing 68 and lead to the coil 86. The contact elements 90 can, for example, be configured as insulation-piercing contacts so that when the drain valve 70, which is designed as a plug-in valve, is inserted, an electric connection is established as soon as the electromagnetic actuator 72 is placed on the radial extension 66, which serves as a mounting flange, and is there attached when the drain valve 70 is pushed into the receiving element 68.

This configuration makes it possible to avoid a separate control unit for the electromagnetic actuator 72 of the drain valve 70, which can instead be integrated into the control unit 28 of the blower 10, which is then used to switch the power supply to the coil 86 on and off in order to empty the condensate drain channel 60 or to keep it closed.

The anode gas of the recirculation path is accordingly used to directly cool the electric motor driving the blower, and at the same time water is continuously removed from this gas. The device for anode gas recirculation also contains the necessary elements for controlling and carrying out a discharge of the condensate by controlled emptying. This can, for example, always be carried out when the condensate drain channel is filled to a certain level, but should be carried out during operation of the fuel cell if the water is to be drained to the cathode. A defined liquid level must accordingly be maintained in the condensate drain channel, wherein the draining can take place depending on a detected filling. This integration reduces the required packaging space and integrates several system functions into a single component, thereby reducing costs.

It should be clear that the described device for anode gas recirculation in a fuel cell system is not limited to the described embodiment. For example, if the blower is a side channel blower, a second condensate drain can be configured at the lowest point in the delivery channel, as viewed in the direction of rotation of the rotor wheel, immediately before an intermediate section of the delivery channel, which can also be used to separate residual moisture that enters the delivery channel. This can also be provided by using a solenoid valve, which can then be configured in a receiving element on an extension on the blower head cover. Various droplet separators can also be used, or the various outlets for the separated substances shown can be combined in different ways with the various possibilities for separation. The drain valve can of course also be configured with a separate control unit and a separate plug. The plug of the blower can also be connected to a control unit of the actuator integrated in the drain valve. The condensate drain channel can alternatively also be located not at the outer motor housing part, but instead extend downwards through the other parts of the outer housing, i.e., the blower housing and, if applicable, the blower head cover. The opening for draining the condensate would in this case be configured in the wall that is axially limiting at the bottom.

The present invention is not limited to embodiments described herein; reference should be had to the appended claims.

### LIST OF REFERENCE NUMERALS

10 Blower
11 Housing
12 Outer motor housing part
14 Blower housing
16 Blower head cover
18 Inner motor housing part
20 Electric motor
22 Rotor wheel
24 Delivery channel
26 Cover
28 Control unit
30 Windings
32 Stator
34 Plug
36 Permanent magnetic rotor
38 Drive shaft
40 Flange
42 Delivery channel outlet
44 Cooling channel inlet
46 Cooling channel
48 Inner wall
50 Baffle plate
52 Droplet separator
54 Wall
56 Opening
58 Inlet
60 Condensate drain channel
62 Anode gas outlet
64 Delivery channel inlet
66 Radial extension
68 Receiving element
70 Drain valve
72 Electromagnetic actuator
74 Closing member
76 Valve seat
78 Extension (of condensate drain channel 60)
80 Nozzle
82 Condensate outlet
84 Electrical contact lines
86 Coil
88 Contact lug
90 Contact element
92 Actuator housing

What is claimed is:

1-19. (canceled)

20. A device for an anode gas recirculation in a fuel cell system, the device comprising:
a blower comprising a rotor wheel, a delivery channel, an electric motor comprising a drive shaft to which the rotor wheel is attached, and a cooling channel through which an anode gas flows, wherein,
the delivery channel extends from a delivery channel inlet to a delivery channel outlet, and
the cooling channel is arranged to at least partially surround the electric motor of the blower;
an outer housing which defines the blower;
a condensate drain channel which extends below the cooling channel in the outer housing;
a receiving element arranged at the outer housing; and
a drain valve arranged in the receiving element,
wherein,
the cooling channel is fluidically connected to the condensate drain channel, and
the condensate drain channel is configured to be opened and closed by the drain valve so that a liquid can be drained from the condensate drain channel.

21. The device as recited in claim 20, wherein,
the outer housing comprises a blower housing which comprise a blower head cover, the blower head cover axially bordering the blower at a bottom thereof, and
the receiving element for the drain valve is arranged at the blower head cover of the outer housing.

22. The device as recited in claim 21, wherein,
the outer housing comprises a radially outer motor housing part which radially surrounds the electric motor of the blower, and
the receiving element is further arranged at the radially outer motor housing part of the outer housing.

23. The device as recited in claim 20, wherein the cooling channel is configured as a droplet separator.

24. The device as recited in claim 20, wherein the drain valve is configured to be switched as a function of a filling level of the liquid in the condensate drain channel.

25. The device as recited in claim 20, wherein, the drain valve comprises an actuator, and the actuator is an electromagnetic actuator.

26. The device as recited in claim 25, wherein the blower further comprises a control unit which is electrically connected to the drain valve.

27. The device as recited in claim 26, further comprising:
electric contact lines arranged in the outer housing which are configured to connect the control unit of the blower to the actuator of the drain valve.

28. The device as recited in claim 27, wherein,
the actuator comprises at least one of a coil and a control unit, and
the electric contact lines are arranged to project from the outer housing as contact lugs in a region of the receiving element of the outlet valve, and
further comprising:
contact elements which correspond to the contact lugs arranged at the actuator, the contact elements being connected to at least one of the coil and the control unit of the actuator so that, when the drain valve is inserted, an electric contact is established with the at least one of the coil and the control unit of the actuator.

29. The device as recited in claim 25, wherein,
the drain valve further comprises a closing member, and
the condensate drain channel comprises an extension which is arranged above the closing member of the drain valve, the extension being configured as a reservoir.

30. The device as recited in claim 29, further comprising:
an actuator housing which is attached to the outer housing,
wherein,
the drain valve is a plug-in valve,
the closing member of the plug-in-valve is arranged to project into the receiving element, and
the actuator of the drain valve is arranged to project at least partially out of the outer housing.

31. The device as recited in claim 20, wherein,
the drain valve comprises a valve seat, and,
the valve seat arranged in the outer housing.

32. The device as recited in claim 20, wherein the cooling channel comprises an opening which defines an inlet of the condensate drain channel and an anode gas outlet which leads to the delivery channel inlet.

33. The device as recited in claim 32, wherein,
a wall defines a lower end of the cooling channel, and
the wall is configured to slope towards the opening which defines the inlet of the condensate drain channel.

34. The device as recited in claim 33, wherein,
the outer housing comprises an inner wall, and
the inlet of the condensate drain channel is arranged at the inner wall of the outer housing adjacent to a lowest region of the wall which defines the lower end of the cooling channel.

35. The device as recited in claim 34, wherein,
the anode gas outlet of the cooling channel is arranged above the delivery channel and offset radially inwards with respect to the inner wall of the outer housing, and
the anode gas outlet is arranged at a radial distance to the inner wall.

36. The device as recited in claim 32, wherein the anode gas outlet of the cooling channel is arranged to be axially offset from the inlet of the condensate drain channel and above the inlet of the condensate drain channel.

37. The device as recited in claim 20, wherein,
the outer housing comprises a radial extension, and
the condensate drain channel and the receiving element for the drain valve are each arranged in the radial extension of the outer housing.

38. The device as recited in claim 20, wherein the cooling channel helically surrounds the electric motor.
